(19) United States
(12) Patent Application Publication
(10) Pub. No.: US 2009/0071560 A1
(43) Pub. Date: Mar. 19, 2009

(54) HERMETIC COMPRESSOR

(75) Inventor: Yong Yeon Jeong, Gwangju (KR)

Correspondence Address: BLANK ROME LLP, WATERGATE, 600 NEW HAMPSHIRE AVENUE, N.W., WASHINGTON, DC, 20037, US

(73) Assignee: Samsung Gwangju Electronics Co., Ltd., Gwangju-City (KR)

(21) Appl. No.: 12/164,170

(22) Filed: Jun. 30, 2008

(30) Foreign Application Priority Data
Sep. 17, 2007 (KR) 10-2007-0094361

(51) Int. Cl. F16K 15/16; F04B 39/10

(52) U.S. Cl. 137/856; 417/559; 251/64

(57) ABSTRACT

A hermetic compressor having an improved discharge valve assembly to efficiently limit deformation of a stopper caused by a reed valve while achieving efficient opening operation of the reed valve. The hermetic compressor includes a compression chamber and a discharge valve assembly. The discharge valve assembly includes a valve plate, a reed valve provided at one surface of the valve plate to open or close a discharge hole formed in the valve plate allowing communication with the compression chamber, the reed valve having a fixed end fastened to the valve plate and a moveable end adapted to cover the discharge hole of the valve plate, a stopper for covering the reed valve to limit the opening movement of the reed valve, the stopper including a fixed portion coupled to the valve plate and the fixed end of the reed valve, and an extension extending away from the fixed portion adapted to cover the moveable end of the reed valve, and a keeper for covering the stopper to limit deformation of the stopper caused by the reed valve. The extension of the stopper includes a first extension extending obliquely from the fixed end of the reed valve toward the keeper, and a second extension extending obliquely from the first extension toward the reed valve so as not to come into contact, at a distal end thereof, with the valve plate or the keeper when no external force is applied thereto.

### CROSS-REFERENCE TO RELATED APPLICATION

This application claims the benefit of Korean Patent Application No. 10-2007-0094361, filed on Sep. 17, 2007 in the Korean Intellectual Property Office, the entire disclosure of which is incorporated herein by reference.

### FIELD OF THE INVENTION

The present invention relates to a hermetic compressor, and, more particularly, to a hermetic compressor having an improved discharge valve assembly to efficiently limit deformation of a stopper caused by a reed valve while achieving efficient operation and rapid opening of the reed valve.

### BACKGROUND OF THE INVENTION

In general, a hermetic compressor is employed to compress a refrigerant in a refrigeration cycle of a refrigerator, air conditioner, etc. The hermetic compressor includes a hermetic container containing a drive unit to provide a drive force for compression of the refrigerant and a compression unit to compress the refrigerant via the drive force of the drive unit.

The compression unit includes a cylinder having a compression chamber, a piston to rectilinearly reciprocate in the compression chamber via the drive force of the drive unit, and a cylinder head coupled to one end of the cylinder so as to hermetically seal the compression chamber, the cylinder head having a refrigerant suction chamber and a refrigerant discharge chamber which are separated from each other. A valve device is typically interposed between the cylinder and the cylinder head to control the flow of refrigerant to be suctioned from the refrigerant suction chamber into the compression chamber or to be discharged from the compression chamber into the refrigerant discharge chamber.

The refrigerant suction chamber is connected to a suction pipe to guide the refrigerant, which has passed through an evaporator of the refrigeration cycle, into the hermetic container. The refrigerant discharge chamber is connected to a discharge pipe to guide the refrigerant, compressed in the compression chamber, to a condenser of the refrigeration cycle.

With the above-described configuration, when the piston rectilinearly reciprocates in the compression chamber via operation of the drive unit, a pressure difference occurs between the interior and the exterior of the compression chamber, causing the refrigerant, guided into the hermetic container along the suction pipe, to be suctioned, by way of the refrigerant suction chamber, into and compressed in the compression chamber. The compressed refrigerant is discharged from the compression chamber to the refrigerant discharge chamber, to the discharge pipe, and the condenser of the refrigeration cycle.

The valve device conventionally includes a valve plate, which is formed with a suction hole to communicate the refrigerant suction chamber with the compression chamber and a discharge hole to communicate the compression chamber with the refrigerant discharge chamber, a discharge valve assembly provided at one surface of the valve plate facing the refrigerant discharge chamber to open or close the discharge hole, and a suction valve provided at the other surface of the valve plate facing the compression chamber to open or close the suction hole.

FIG. 1 illustrates a prior art discharge valve assembly 1 employed in a conventional hermetic compressor. As shown in FIG. 1, the discharge valve assembly 1 serves to control the flow of a refrigerant discharged, at a high pressure, from the compression chamber 2 into the refrigerant discharge chamber 3. The discharge valve assembly 1 includes a reed valve 5 to cover a discharge hole 4a formed in a valve plate 4, a stopper 6 to cover the reed valve 5 so as to limit an opening angle of the reed valve 5, and a keeper 7 to cover the stopper 6 so as to limit deformation of the stopper 6 caused by the reed valve 5.

A fixed end 5a of the reed valve 5 and a fixed portion 6a provided at one end of the stopper 6 are fixed to the valve plate 4, by means of a first fastening member 8a, together with a first fastening portion 7a provided at one end of the keeper 7, such that the fixed end Sa and the fixed portion 6a come into close contact with the valve plate 4. A second fastening portion 7b provided at the other end of the keeper 7 is fixed to the valve plate 4 by means of a second fastening member 8b.

The discharge hole 4a is covered with a free, movable end 5b of the reed valve 5. An extension 6b of the stopper 6 extending from the fixed portion 6a is provided at a distal end thereof with a restrained portion 6c, which is inserted into and restrained by a recess 7c dented from a surface of the second fastening portion 7b facing the valve plate 4. In a state wherein the stopper 6 is not forced upward by the free, movable end 5b of the reed valve 5, the extension 6b between the fixed portion 6a and the restrained portion 6c is curved convexly upward, and is spaced apart from an upwardly convex portion of the keeper 7 between the first fastening portion 7a and the second fastening portion 7b.

If a high-pressure refrigerant discharged from the compression chamber 2 reaches the discharge hole 4a, the movable end 5b of the reed valve 5 is bent upward by the pressure of the refrigerant. Thereby, the discharge hole 4a is opened, causing the refrigerant discharged from the compression chamber 2 into the refrigerant discharge chamber 3.

In this case, the stopper 6, which is forced upward by the movable end 5b of the reed valve 5, is elastically deformed as the restrained portion 6c is separated from the recess 7c and moves toward the fixed portion 6a until the extension 6b between the fixed portion 6a and the restrained portion 6c comes into contact with the keeper 7, as shown in FIG. 2. Then, if the pressure of the refrigerant passing through the discharge hole 4a is reduced to a value lower than a predetermined pressure, the movable end 5b of the reed valve 5 closes the discharge hole 4a with a restoration force and the stopper 6 restores to its original state and presses the movable end 5b of the reed valve 5 toward the valve plate 4.

However, the above-described discharge valve assembly 1 of the conventional hermetic compressor has the following disadvantage. In this discharge valve assembly 1, the fixed portion 6a provided at one end of the stopper 6 is fastened to the valve plate 4 by the first fastening portion 7a of the keeper 7, and the restrained portion 6c at the other end of the stopper 6 is restrained within the recess 7c so as not to be separated from the recess 7c. The keeper 7, thus, limits the deformation of the stopper 6 during the opening operation of the reed valve 5. That in turn limits the operation of the stopper 6. Consequently, the reed valve 5 often fails to rapidly open, which limits the operating efficiency of the refrigerant compression.

U.S. Pat. No. 6,766,823 issued to Hong and assigned to Samsung Gwangju Electronics Co. is an exemplary discharge valve assembly. The entire disclosure of the '823 Patent is hereby incorporated by reference into the present application.

### SUMMARY OF THE INVENTION

One aspect of the invention is to provide a hermetic compressor having an improved discharge valve assembly to efficiently limit deformation of a stopper caused by a reed valve while achieving more efficient opening operation of the reed valve.

Additional aspects and/or advantages of the invention will be set forth in part in the description of the invention which follows and, in part, will be obvious from the description, or may be learned by practice of the invention.

In accordance with the invention, the above and/or other aspects can be achieved by providing a hermetic compressor including a compression chamber and a discharge valve assembly. The discharge valve assembly includes a valve plate, a reed valve provided at one surface of the valve plate to open or close a discharge hole formed in the valve plate allowing communication with the compression chamber, the reed valve having a fixed end fastened to the valve plate and a moveable end adapted to cover the discharge hole of the valve plate, a stopper for covering the reed valve to limit the opening movement of the reed valve, the stopper including a fixed portion coupled to the valve plate and the fixed end of the reed valve, and an extension extending away from the fixed portion adapted to cover the moveable end of the reed valve, and a keeper for covering the stopper to limit deformation of the stopper caused by the reed valve. The extension of the stopper includes a first extension extending obliquely from the fixed end of the reed valve toward the keeper, and a second extension extending obliquely from the first extension toward the reed valve so as not to come into contact, at a distal end thereof, with the valve plate or the keeper when no external force is applied thereto.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a sectional view of a prior art discharge valve assembly of a conventional hermetic compressor, with a discharge hole being closed;

FIG. 2 is a sectional view of the prior art discharge valve assembly of the conventional hermetic compressor, with the discharge hole being open;

FIG. 3 is a cross sectional plan view of a hermetic compressor in accordance with an exemplary embodiment of the present invention;

FIG. 4 is an exploded perspective view illustrating a valve device of a hermetic compressor in accordance with an exemplary embodiment of the present invention;

FIG. 5 is an exploded perspective view illustrating a discharge valve assembly provided in the valve device of the hermetic compressor in accordance with an exemplary embodiment of the present invention;

FIG. 6 is a sectional view of the discharge valve assembly provided in the valve device of the hermetic compressor in accordance with an exemplary embodiment of the present invention, with a discharge hole being closed; and

FIG. 7 is a sectional view of the discharge valve assembly provided in the valve device of the hermetic compressor in accordance with an exemplary embodiment of the present invention, with the discharge hole being open.

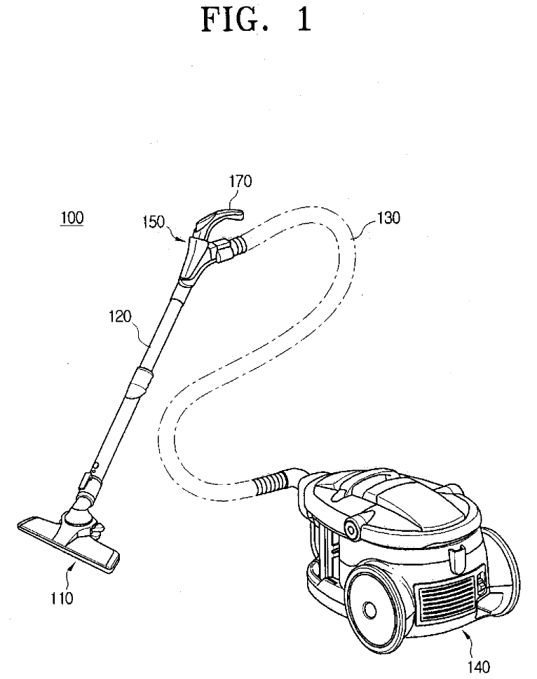

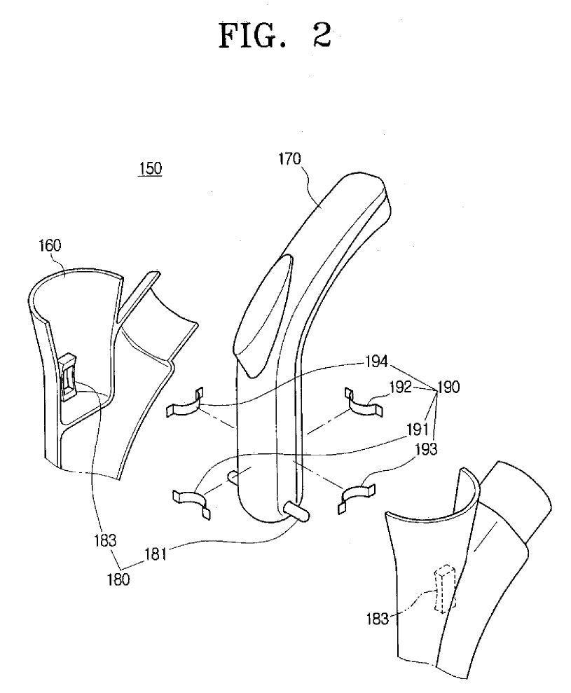

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to like elements throughout. The embodiments are described below to explain the present invention by referring to the figures.

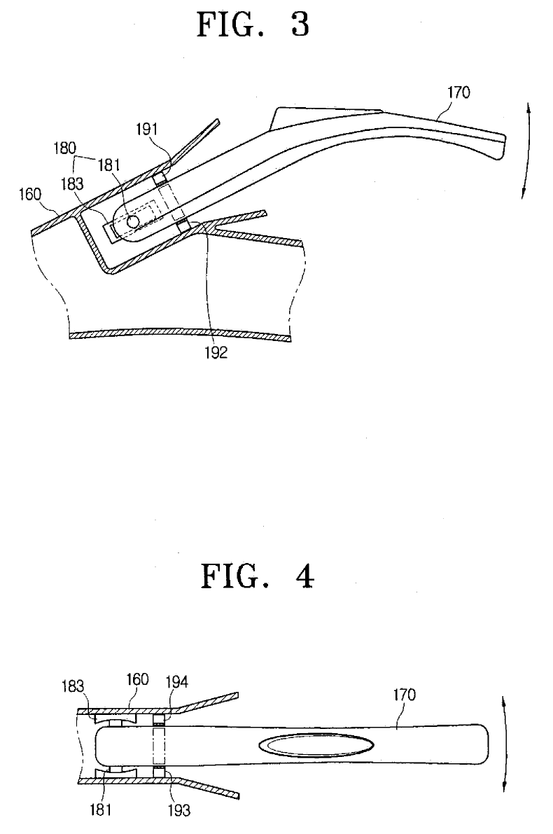

FIG. 3 illustrates a cross sectional view of a hermetic compressor in accordance with a preferred embodiment of the present invention. The hermetic compressor includes a hermetic container 10 defining an external appearance of the hermetic compressor. The hermetic container 10 may be provided with a suction pipe 11 to guide a refrigerant, having passed through an evaporator of a refrigeration cycle, into the hermetic container 10 and a discharge pipe 12 to guide the refrigerant, compressed within the hermetic container 10, to a condenser of the refrigeration cycle. A drive unit 20 to provide a drive force for compression of the refrigerant and a compression unit 30 to compress the refrigerant upon receiving the drive force of the drive unit 20 are installed in the hermetic container 10 via a frame 40.

The drive unit 20 may include a stator 21 installed around an upper portion of the frame 40, a rotor 22 rotatably installed inside the stator 21 to rotate via electromagnetic interaction with the stator 21, and a rotating shaft 23 press-fitted in the center of the rotor 22 to rotate together with the rotor 22. A lower end of the rotating shaft 23 extends downward by passing through the center of the frame 40, defining an eccentric shaft portion 23a to eccentrically rotate.

The compression unit 30 may include a cylinder 31 formed at a side of a lower portion of the frame 40 and having a compression chamber 31a, and a piston 33 connected with the eccentric shaft portion 23a via a connecting rod 32 to rectilinearly reciprocate in the compression chamber 31a when the eccentric shaft portion 23a eccentrically rotates according to rotation of the rotating shaft 23.

The compression unit 30 may further include a cylinder head 34 coupled to one end of the cylinder 31 so as to hermetically seal the compression chamber 31a and having a refrigerant suction chamber 34a and a refrigerant discharge chamber 34b which are separated from each other, and a valve device 35 interposed between the cylinder 31 and the cylinder head 34 to control the flow of refrigerant to be suctioned from the refrigerant suction chamber 34a into the compression chamber 31a or to be discharged from the compression chamber 31a into the refrigerant discharge chamber 34b.

With the above-described configuration, an electromagnetic interaction between the stator 21 and the rotor 22 causes the rotor 22 and the rotating shaft 23 to rotate together. As a result, the piston 33, which is connected with the eccentric shaft portion 23a via the connecting rod 32, rectilinearly reciprocates in the compression chamber 31a, creating a pressure difference between the interior and the exterior of the compression chamber 31a. The pressure difference allows the refrigerant, which is directed into the hermetic container 10 along the suction pipe 11 from the evaporator of the refrigeration cycle, to be suctioned, by way of the refrigerant suction chamber 34a, into and compressed in the compression chamber 31a. The compressed refrigerant may be discharged from the compression chamber 31a into the refrigerant discharge chamber 34b, and thereafter, is supplied to a condenser of the refrigeration cycle along the discharge pipe 12.

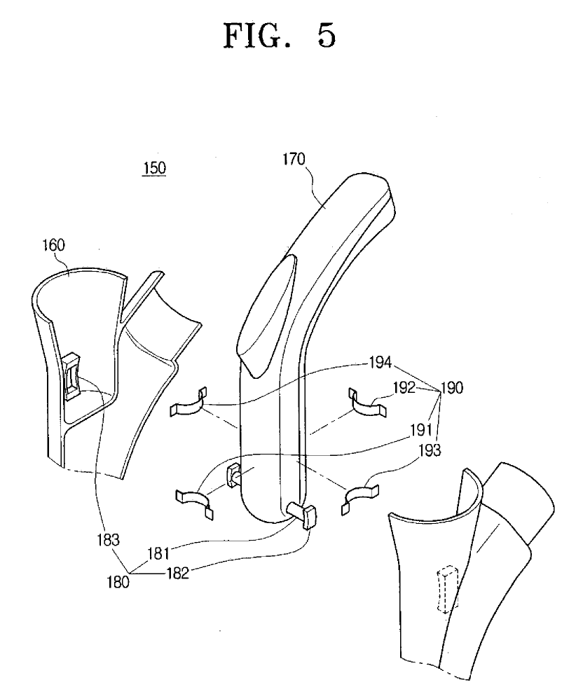

FIGS. 4 and 5 illustrate exploded views of the valve device 35. As shown in FIGS. 4 and 5, the valve device 35 may include a valve plate 51, which is formed with a suction hole 51a providing communication between the refrigerant suction chamber 34a and the compression chamber 31a, and a discharge hole 51b providing communication between the compression chamber 31a and the refrigerant discharge chamber 34b, a discharge valve assembly 60 provided at one surface of the valve plate 51 toward the refrigerant discharge chamber 34b to open or close the discharge hole 51b. A suction valve plate 52 covers the entire other surface of the valve plate 51 toward the compression chamber 31a to open or close the suction hole 51a. First and second gaskets 53 and 54 may be provided to prevent leakage of the refrigerant.

The first gasket 53 may be interposed between the valve plate 51 and the cylinder head 34, and the second gasket 54 may be interposed between the suction valve plate 52 and the cylinder 31. A reed valve 52a is preferably integrally formed at the center of the suction valve plate 52 by cutting. The reed valve 52a may also be formed separately and attached to the suction valve plate 52. The reed valve 52a serves as a suction valve to open or close the suction hole 51a.

The discharge valve assembly 60 is used to control the flow of the refrigerant discharged, at a high pressure, from the compression chamber 31a to the refrigerant discharge chamber 34b. The assembly 60 (FIG. 5) includes a reed valve 70 to close and open the discharge hole 51b, a stopper 80 to cover the reed valve 70 so as to limit the opening movement of the reed valve 70, and a keeper 90 to cover the stopper 80 so as to limit deformation of the stopper 80 caused by the reed valve 70.

More specifically, as shown in FIG. 6, the reed valve 70 has a fixed end 71 and a free, movable end 72 to open or close the discharge hole 51b. The free end 72 is pivotally movable about the fixed end 71 so as to be bent away from the valve plate 51 to open the discharge hole 51b. The stopper 80 has a fixed portion 81 at one end and an extension 82 at the other end, extending from the fixed portion 81 to cover the movable end 72 of the reed valve 70. The fixed portion 81 of the stopper 80 and the fixed end 71 of the reed valve 70 are fixed to the valve plate 51 by a first fastening member 101 in the form of a rivet, together with a first fastening portion 91 provided at one end of the keeper 90, such that the fixed end 71 and the fixed portion 81 come into close contact with the valve plate 51. A second fastening portion 92 provided at the other end of the keeper 90 is fixed to the valve plate 51 by means of a second fastening member 102. A portion of the keeper 90 between the first fastening portion 91 and the second fastening portion 92 defines an upwardly convex portion 93 to receive the extension 82 of the stopper 80 and the movable end 72 of the reed valve 70 between the valve plate 51 and the keeper 90.

The extension 82 of the stopper 80 includes a first extension 82a and a second extension 82b. The first extension 82a extends obliquely away from the valve plate 51 by being bent from the fixed portion 81 such that a distal end thereof is supported by the upwardly convex portion 93 of the keeper 90. The second extension 82b extends obliquely toward the valve plate 51 by being bent from the first extension 82a, so as not to come into contact, at a distal end thereof, with the valve plate 51 and the keeper 90 when no external force is applied thereto. A bent portion at the junction of the fixed portion 81 and the first extension 82a is a first bent portion 82c, which is in contact with the fixed end 71 of the reed valve 70. A bent portion at the junction between the first extension 82a and the second extension 82b is a second bent portion 82d, which is in contact and supported by the upwardly convex portion 93 of the keeper 90.

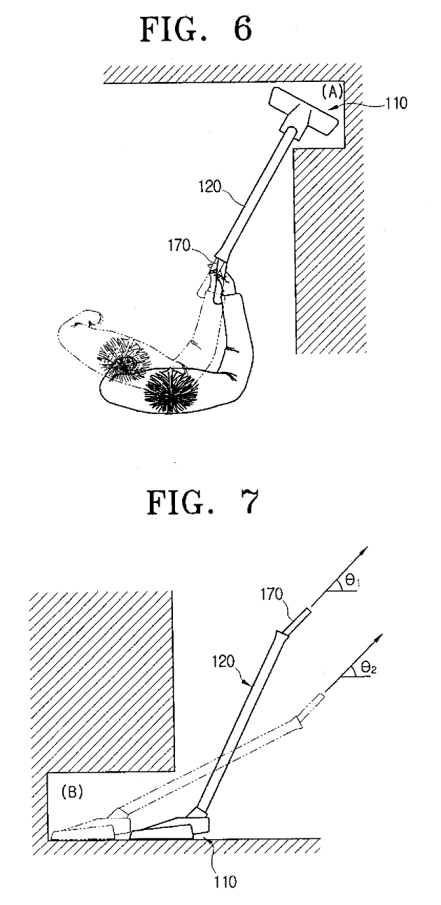

The above-described stopper 80, having the extension 82 to cover the movable end 72 of the reed valve 70, as shown in FIGS. 6 and 7, is continuously supported by the keeper 90 via the second bent portion 82d even in a state wherein the discharge hole 51b is opened by the reed valve 70. This has the effect of efficiently limiting excessive deformation of the stopper 80 caused by the reed valve 70.

Also, when the discharge hole 51b is closed, the second extension 82b has a distal end not in contact with or restrained by the valve plate 51 or the keeper 90, as shown in FIG. 7. The second extension 82b can be freely pushed away from the valve plate 51 and toward the keeper 90 by the movable end 72 of the reed valve 70 when the discharge hole 51b is opened. Accordingly, the second extension 82b can move easily about the second bent portion 82d. As a result, the discharge valve assembly 60 in accordance with the present embodiment enables rapid opening operation of the reed valve 70 while achieving a further improvement of refrigerant compression efficiency.

Preferably, the first extension 82a is shorter than the movable end 72 of the reed valve 70, to allow the second extension 82b to substantially limit an opening angle of the movable end 72 of the reed valve 70 as the first extension 82a is bent upward on the basis of the second bent portion 82d.

Even if the first extension 82a is shorter than the movable end 72 of the reed valve 70, when the second bent portion 82d is located to correspond to the discharge hole 51b, the second extension 82b is difficult to be pushed and be bent upward by the movable end 72 of the reed valve 70. Therefore, more preferably, the stopper 80 is located such that the second bent portion 82d is located between the fixed portion 81 and the discharge hole 51b.

As apparent from the above description, in a discharge valve assembly of a hermetic compressor according to the present invention, an extension of a stopper, which is provided to cover a movable end of a reed valve for limiting the opening movement of the reed valve, includes a second bent portion supported by a keeper, and a second extension extending from the second bent portion so as not to come into contact with the keeper and the valve plate when no external force is applied.

With the discharge valve assembly of the hermetic compressor in accordance with the present invention, the second extension of the stopper, which covers the movable end of the reed valve, can be supported by the keeper at the second bent portion. Consequently, deformation of the stopper caused by the reed valve can be efficiently limited by the keeper. Further, the second extension of the stopper, which limits the opening angle of the movable end of the reed valve, can move freely without being restrained by the keeper or valve plate, resulting in more efficient opening operation of the reed valve.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A hermetic compressor comprising of:
a compression chamber; and
a discharge valve assembly including:
a valve plate;
a reed valve provided at one surface of the valve plate to open or close a discharge hole formed in the valve plate allowing communication with the compression chamber, the reed valve having a fixed end fastened to the valve plate and a moveable end adapted to cover the discharge hole of the valve plate;
a stopper for covering the reed valve, limiting the opening movement of the reed valve, the stopper including a fixed portion coupled to the valve plate and the fixed end of the reed valve, and an extension extending away from the fixed portion adapted to cover the moveable end of the reed valve; and
a keeper for covering the stopper to limit deformation of the stopper caused by the reed valve;
wherein the extension of the stopper includes a first extension extending obliquely from the fixed end of the reed valve toward the keeper, and a second extension extending obliquely from the first extension toward the reed valve so as not to come into contact, at a distal end thereof, with the valve plate or the keeper when no external force is applied thereto.

2. The compressor according to claim 1, wherein the first extension is shorter than the moveable end of the reed valve.

3. The compressor according to claim 1, wherein the stopper further comprises:
a first bent portion provided between the fixed portion and the first extension; and
a second bent portion provided between the first extension and the second extension;
wherein the second bent portion is provided at a position between the fixed portion and the discharge hole.

4. A discharge valve assembly for a hermetic compressor, comprising:
a plate having a discharge hole;
a valve having a fixed end and a movable end, for closing and opening the discharge hole;
a stopper having a fixed portion and an extension portion extending away from the fixed portion, the stopper limiting an opening movement of the valve; and
a keeper having first and second ends, the keeper limiting deformation of the stopper caused by a movement of the movable end of the valve;
wherein the fixed end of the valve, the fixed portion of the stopper, and the first end of the keeper are coupled to the plate, and
wherein the extension portion of the stopper includes a first extension extending obliquely from the fixed portion of the valve toward the keeper, and a second extension extending obliquely from the first extension toward the valve so as not to come into contact, at a distal end thereof, with the valve plate or the keeper when the discharge hole is closed.

5. The discharge valve assembly according to claim 4, wherein the keeper farther comprises a convex portion between the first and second ends; and
the second end is fastened to the plate.

6. The discharge valve assembly according to claim 5, wherein the fixed end of the valve, the fixed portion of the stopper, and the first end of the keeper are fastened to the plate by a first fastening member; and
the second end of the keeper is fastened to the plate by a second fastening member.

7. The discharge valve assembly according to claim 6, wherein the extension portion of the stopper includes a first extension extending from the fixed portion toward the keeper and away from the plate, and a second extension, longer than the first extension, extending from an end of the first extension toward the plate and away from the keeper; and
wherein an end of the second extension is the distal end of the extension portion.

8. A discharge valve apparatus for a hermetic compressor, comprising:
a plate having a discharge hole;
a valve having a fixed end fastened to the plate and a movable end for opening and closing the discharge hole; and
a stopper for covering the valve, limiting the opening movement of the valve, the stopper having a first flat portion coupled to the plate, a second flat portion extending obliquely from the first portion, in a direction away from the plate, to a bent portion located remotely from the plate, and a third flat portion extending obliquely from the bent portion, in a direction toward the plate, to a distal end.

9. The discharge valve apparatus of claim 8, wherein the distal end of the stopper is free from being in contact with the keeper or the valve when no external force is applied to the stopper.

10. The discharge valve apparatus of claim 8, further comprising:
a keeper for covering the stopper to limit deformation of the stopper caused by the opening of the valve, having first and second ends and a body extending between the first and second ends;
wherein the first end of the keeper, the fixed end of the valve and the first portion of the stopper are fastened to the plate by a first fastening member;
the second end of the keeper is fastened to the plate by a second fastening member; and
the bent portion of the stopper is substantially in contact with the body of the keeper.

11. The compressor apparatus according to claim 10, wherein, for the stopper, the second flat portion is shorter than the third flat portion.

12. The compressor apparatus according to claim 11, wherein the bent portion is located in an area between the first fastener and the discharge hole.

13. The compressor apparatus according to claim 12, wherein the body of the keeper has a convex configuration.
